(19) United States
(12) Patent Application Publication
(10) Pub. No.: US 2007/0284548 A1
(43) Pub. Date: Dec. 13, 2007

(54) Particle therapy plan and method for compensating for an axial deviation in the position of a particle beam of a particle therapy system

(76) Inventors: Werner Kaiser, Langquaid (DE); Vitali Lazarev, Rottenbach (DE); Heiko Rohdjess, Grossenseebach (DE)

Correspondence Address: BRINKS HOFER GILSON & LIONE, P.O. BOX 10395, CHICAGO, IL, 60610, US

(21) Appl. No.: 11/717,558

(22) Filed: Mar. 12, 2007

(30) Foreign Application Priority Data
Mar. 20, 2006 (DE) DE 102006012680.7

(51) Int. Cl. H01J 29/02

(52) U.S. Cl. 250/522.1

(57) ABSTRACT

A particle therapy system is provided. The particle therapy system includes a rotatable gantry being operable to generate a particle beam during operation and a measuring instrument for determining a position of the particle beam. The gantry is movable in the axial direction to correct a deviation in the position of the particle beam from an axial set-point position.

This patent document claims the benefit of DE 10 2006 012 680.7 filed Mar. 20, 2006, which is hereby incorporated by reference.

### BACKGROUND

The present embodiments relate to a particle therapy system and a method for compensating for an axial deviation in the position of a particle beam of a particle therapy system having a rotatable gantry.

Radiation therapy is currently becoming more important. Particle therapy may be used to treat cancer using protons or heavy ions. Particle therapy is employed for patients for whom conventional radiation therapy cannot be adequately used. Conventional radiation therapy may not be adequate because the tumor is seated too deeply in the body or because it is surrounded by sensitive organs. Particle therapy is sometimes completed using a rotatable gantry. The rotatable gantry surrounds a radiation treatment chamber into which a patient table is placed.

For the most precise possible radiation treatment, the patient's tissue, which is to be irradiated, must be positioned as precisely as possible in the isocenter (for example, the target point of the beam upon rotation of the gantry) of the system. The target precision of the beam is effected by the patient positioning, the geometric precision of the gantry, and other factors. Thermal expansion of the gantry, bearing errors, or deformation caused by gravity cause deviations of the isocenter from its set-point position, where the tissue to be irradiated is placed.

In a cylindrical coordinate system, the deviations can be described by an axis of rotation, a radial direction, and an angular position of the gantry. The deviation in the radial direction is not critical for the radiation treatment because the beam travel is lengthened or shortened by air. Changing the beam travel in air has an insignificant influence on the penetration depth of the beam in the patient. The penetration depth depends primarily on the beam energy. The deviations in the radial direction may be ignored. However, the deviations along the axis of rotation and in the angular position of the gantry do have an adverse effect on the precise guidance of the beam and must be corrected during operation of the gantry.

One method for determining the shape, size, and site of the geometric center of a mechanical isocenter in radiotherapy treatment units with a rotatable gantry, and a construction of a proton gantry, are described in “Isocenter characteristics of an external ring proton gantry,” Int. J. Radiat. Oncol. Biol. Phys. 60 (2004), pp. 1622-1630, by M. F. Moyers and W. Lesyna.

U.S. Pat. No. 4,112,306 A describes the construction of a neutron therapy system. The neutron therapy system has a gantry for tilting a cyclotron. The protons required for generating neutrons are accelerated in the cyclotron. The neutrons leave the cyclotron via a collimator. The cross section of the collimator is variable.

German Patent Disclosure DE 102 41 178 A1 describes a gantry for isokinetic guidance of a particle beam. The isokinetic guidance has magnets, which deflect the particle beam that is inserted axially by a particle accelerator. The gantry includes a rotationally symmetrical primary structure. The rigidity of the primary structure is dimensioned such that the vertical displacements of the magnets because of their weight are the same size (isokinetic) in all directions. The magnets are moved along circular paths around a theoretical axis of rotation that in the unloaded state is displaced relative to a horizontal longitudinal axis of the gantry arrangement. The intersection between the particle emitter and the load-displaced theoretical axis of rotation is defined as the irradiation target point. The primary structure is supported by two supporter rings provided on its ends. The two supporter rings correspond to stationary bearing stands. One of the stationary bearing stands is a loose bearing. The other stationary bearing stand is a fixed bearing.

### SUMMARY

The present embodiments may obviate one or more of the drawbacks or limitations inherent in the related art. For example, in one embodiment, a particle therapy system is able to compensate for a deviation of its isocenter. In another exemplary embodiment, a method for compensating for a deviation in the position of an isocenter of a particle therapy system makes high target accuracy of the particle beam possible.

In one embodiment, a particle therapy system includes a rotatable gantry having a particle beam that can be generated in operation, and a measuring instrument. The measuring instrument determines a position of the particle beam in the axial direction. The gantry is movable in the axial direction to correct a deviation in the position of the particle beam from an axial set-point position.

Even if deviations occur in the position of the isocenter, for example, from thermal expansion of the gantry, high precision and particle irradiation of a tumor is achieved by determining and correcting the position of the particle beam, in particular during the irradiation. At the beginning of the irradiation, the location of the isocenter of the gantry is detected. The tissue to be irradiated is positioned in the isocenter. The outset position of the isocenter, in which the tumor is located during the radiation treatment, is a set-point position of the isocenter. If an axial deviation in the position of the particle beam that leads to a deviation in the location of the isocenter is ascertained, the gantry is moved in the axial direction, for example, along its axis of rotation, in order to correct this deviation.

In one embodiment, an extremely high target accuracy of the particle beam is assured. Compensation for the deviation of the isocenter or of the particle beam is attainable on the order of magnitude of 0.1 mm.

In one embodiment, the position of the particle beam may be determined using a measuring instrument during the irradiation. The measuring instrument detects the current position of the particle beam either continuously or repeatedly. In an alternative embodiment, a series of calibration measurements may be performed. The calibration measurements may be used to ascertain a relationship, for example, between the gantry parameters, the ambient temperature, the position of a beam-determining element (i.e. the last magnet in the direction of the beam course), and the position of the particle beam. During the irradiation of the patient, the position of the beam-determining element can be measured by a measuring instrument, and the position of the particle beam can be ascertained taking the measurement series into account.

In one embodiment, if deviations are detected, the movement of the gantry is achieved structurally. The gantry is supported by a loose bearing and a displaceable fixed bearing. The loose bearing is provided on a front housing part, in the region of a beam exit. The displaceable fixed bearing is provided on a rear housing part. The gantry includes an at least two-part cylindrical housing. The different housing parts are of different sizes. The front housing part of the gantry surrounds a radiation treatment chamber, into which a patient table is driven (disposed). The beam enters the gantry at the rear housing part, which is on the other end of the gantry. The rear housing part has a diameter which is smaller by approximately three times than the diameter of the front housing part. A bearing that is located on the front housing part must withstand greater loads than a bearing that is provided on the rear housing part. A loose bearing is used in the region of the front housing part. The loose bearing receives solely radial forces. The gantry, in its expansion, can “wander” (shift) in the region of the loose bearing. This shifting of the gantry relative to the fixed loose bearing is detected by determining the position of the particle beam. The correction of the position of the particle beam is done by the displacement of the fixed bearing. The fixed bearing, which receives both radial and axial forces, is fixed to the gantry. The fixed bearing's relative position to the gantry does not change. The fixed bearing is moved together with the gantry in order to compensate for the deviations in the position of the particle beam.

In one embodiment, the measuring instrument includes an optical travel measuring system. The optical travel measuring system can directly measure the position of the particle beam. Contactless optical measuring systems have a low wear resistance and high resolution. The resolution is on the order of 0.005% to 0.1% of the measurement range. The low wear resistance and high resolution permits excellent accuracy in determining the position of the particle beam and in correcting the deviation. The position of the particle beam can be measured, for example, by placing a film in the beam path and performing a geometric evaluation of the spot formed by the particle beam. The beam spot may be evaluated, for example, on a fluorescent screen, using a CCD camera.

In one embodiment, the loose bearing is a hydrostatic radial bearing. Hydrostatic bearings include a circulation of lubricant, which assures virtually wear-free operation.

In one embodiment, a guide for the fixed bearing is provided. A guide has only one degree of translational freedom, so that a predetermined compulsory motion of the fixed bearing is attained. The gantry is moved only in the axial direction. The guide maybe, for example, a rail, a shaft guide, or a roller guide.

In one embodiment, a locking element locks the fixed bearing to prevent displacement of the particle beam from a departure of the fixed bearing from its corrected position. The locking element may be, for example, a securing bolt, a screw, or a clamping device.

In one embodiment, a method for compensating for an axial deviation in the position of a particle beam of a particle therapy system having a rotatable gantry, in which a position of the particle beam is determined, and upon a deviation of this position from an axial set-point position, the method includes moving the gantry in the axial direction in such a way that the deviation is corrected.

In one embodiment, the gantry is supported via one fixed loose bearing and one displaceable fixed bearing in such a way that when the gantry is moved for correcting the deviation, the fixed bearing is displaced. The position of the particle beam may also be measured optically.

In one embodiment, the deviation in the position of the particle beam is measured and corrected at regular time intervals. For example, the position of the particle beam is ascertained approximately every 30 minutes during the radiation treatment. The deviation in the particle beam position, for example, caused by mechanical deformations or thermal expansions of the gantry, occurs very slowly. It is thus assured that the radiation treatment of the patient is not interrupted unnecessarily often by the measurements.

In one embodiment, the fixed bearing is locked in its corrected position.

In one embodiment, the gantry is rotated to compensate for the deviation in an angular position of the particle beam. The particle beam is repositioned by the drive of the gantry to correct for the deviated angular position of the gantry.

### BRIEF DESCRIPTION OF THE DRAWINGS

FIG. 1 shows a cross section view of one embodiment of a particle therapy system that includes a gantry and a measuring instrument; and

FIG. 2 is a front view of one embodiment of the gantry of FIG. 1.

### DETAILED DESCRIPTION

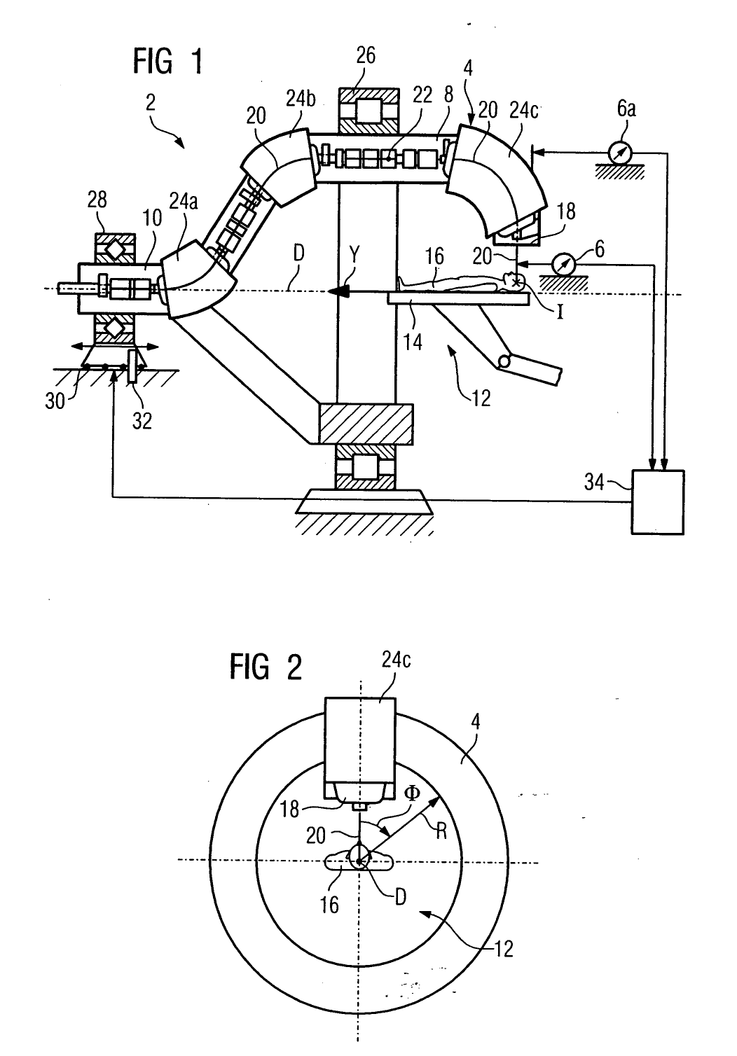

In one embodiment, as shown in FIG. 1, a particle therapy system 2 includes a rotatable gantry 4 and a measuring instrument 6, 6a. As shown in FIG. 1, the axial direction of the gantry 4, which also matches the axis of rotation D, is marked Y. In the axial direction Y, the gantry 4 has one front and one rear housing part 8, 10. The front housing part 8 includes a radiation treatment chamber 12. A patient table 14, with a patient 16 lying on it, may be moved into the radiation treatment chamber 12. An exit window 18, also referred to as a nozzle, protrudes from a wall of the radiation treatment chamber 12. A particle beam 20, for example, a proton beam may exit from the exit window. The patient 16 is positioned in such a way that the tissue to be irradiated is located in the isocenter I of the gantry 4. A set-point position of the isocenter I or of the particle beam 20 is defined. The isocenter I or particle beam 20 should not deviate from the set-point position of the isocenter I or of the particle beam 20 during the radiation treatment. Deviation from the set-point position of the isocenter I or of the particle beam 20 may result in possible damage to the tissue surrounding the tumor.

In one embodiment, the rear housing part 10 has a smaller diameter than the front housing part 8. The particle beam 20 enters the gantry 4 in the region of the rear housing 10 from a particle accelerator. The particle beam 20 is guided in the direction of the nozzle 18 via a beam guide 22. The beam guide may include magnets 24a, 24b, 24c that deflect the particle beam 20.

In one embodiment, the gantry 4 is supported rotatably by two bearings 26, 28. A loose bearing 26, which is fixed, is disposed on the front housing part 8. This loose bearing 26 receives only radial forces, for example, forces perpendicular to the axial direction Y. The loose bearing 26 may include a hydrostatic radial bearing. A fixed bearing 28 is disposed on the rear housing part 10. The fixed bearing 28 receives both radial and axial forces. The fixed bearing 28 may be displaced axially via a guide 30, as indicated in FIG. 1 by a double arrow. Once the fixed bearing 28 is in a desired position, it is locked in this position by a locking element 32.

In one embodiment, the position of the particle beam 20 in the radiation treatment chamber 12 is determined using a measuring instrument 6 and/or the measuring instrument 6a. The measuring instrument 6 in one embodiment is a contactless optical travel measuring system, which directly ascertains the location of the particle beam 20. Thermal expansion of the gantry 4displaces the gantry 4 relative to the fixed loose bearing 26, in the opposite direction of the arrow Y. Displacement of the gantry 4 due to thermal expansion occurs very slowly and causes a displacement of the particle beam 20. The displacement of the gantry 4 may be checked at regular time intervals, for example, approximately every 30 minutes, during the radiation treatment of the patient 16 whether a deviation in the position of the particle beam 20 that leads to a displacement in the isocenter I is present.

In one embodiment, a control unit 34 is connected to the measuring instrument 6 and to the guide 30. The control unit 34 evaluates the signals of the measuring instrument 6. When there is a deviation of the isocenter I from the set-point position, the control unit 34 triggers the guide 30 so that the deviation is compensated for by a movement of the gantry 4. The fixed bearing 20 is locked in its corrected position.

In one embodiment, the control unit 34 is connected to the measuring instrument 6, which directly measures the position of the particle beam 20, and/or a measuring instrument 6a. The measuring instrument 6a may be an optical travel measuring system and serve to determine the position of an element of the beam guide 22. For example, the measuring instrument 6a may determine the position of the last magnet 24c before the nozzle 18. The measuring instrument 6a may use previously made calibration measurements, which indicate the position and orientation of the particle beam 20 as a function of the position of the magnet 24a, the parameters of the gantry, and the ambient temperature.

A front view on the gantry 4 is shown in FIG. 2. In FIG. 2, a radial direction R of the gantry 4 is shown. As shown in FIG. 2, the nozzle 18 can be moved in an angle Φ in order to irradiate the tumor from a different angular position. The radial direction R, the angle Φ, and the axial direction Y, define the axes of a cylindrical coordinate system along which the particle beam 20 can be displaced in the event of thermal expansions or mechanical deformations of the gantry 4.

Deviations of the particle beam 20 in the radial direction R are insignificant because the influence on the penetration depth of the particle beam 20 in the body of the patient 16 is insignificant. The penetration depth of the particle beam 20 depends primarily on the energy of the beam 20. A longer or shorter beam travel in air has essentially no effect on the beam energy. In the present embodiments, a deviation in the angular position of the nozzle 18 is corrected by rotating the gantry 4 about its axis of rotation D until the particle beam 20 or the isocenter I is again located in its set-point position. In FIG. 2, the axis of rotation D is represented only as a point. Correction is done via the independent drive of the gantry 4. The independent drive is triggered by the control unit 34 shown in FIG. 1. Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A particle therapy system comprising:
a rotatable gantry;
a particle beam that can be generated during operation; and
a measuring instrument operable to determine a position of the particle beam,
wherein the gantry is movable in an axial direction to correct a deviation in the position of the particle beam from an axial set-point position.

2. The particle therapy system as defined by claim 1, wherein the gantry is supported by a loose bearing that is provided on a front housing part and a displaceable fixed bearing that is provided on a rear housing part.

3. The particle therapy system as defined by claim 1, wherein the measuring instrument includes an optical travel measuring system.

4. The particle therapy system as defined by claim 2, wherein the loose bearing includes a hydrostatic radial bearing.

5. The particle therapy system as defined by claim 2, comprising a guide for the fixed bearing.

6. The particle therapy system as defined by claim 2, comprising a locking element that is operable to lock the fixed bearing.

7. A method for compensating for an axial deviation in the position of a particle beam of a particle therapy system having a rotatable gantry (4), the method comprising:
determining an axial set-point position of the particle beam;
determining a deviation of the particle beam position from the axial set-point position; and
moving the gantry in an axial direction so that the deviation is corrected.

8. The method as defined by claim 7, wherein the gantry is supported via one fixed loose bearing and one displaceable fixed bearing in such a way that when moving the gantry the fixed bearing is displaced.

9. The method as defined by claim 7, wherein determining the deviation comprises optically measuring the position of the particle beam.

10. The method as defined by claim 7, wherein determining the deviation in the position of the particle beam and moving the gantry are completed at regular time intervals.

11. The method as defined by claim 8, comprising: locking the fixed bearing in its corrected position.

12. The method as defined by claim 8, comprising: rotating the gantry to compensate for the deviation in an angular position of the particle beam.

13. The particle therapy system as defined by claim 2, wherein the particle beam exits the gantry from the front housing part.

14. The particle therapy system as defined by claim 5, comprising a locking element that is operable to lock the fixed bearing.

15. The particle therapy system as defined by claim 1, wherein system is operable to detect and correct a deviation in the position of the particle beam from an axial set-point position of 1 mm.
